(19) United States
(12) Patent Application Publication
(10) Pub. No.: US 2013/0260888 A1
(43) Pub. Date: Oct. 3, 2013

(54) PHASED GAME PLAY FOR SYNCHRONIZED GAMING SCHEDULE

(71) Applicants: John Thornton, Kirkland, WA (US); Jason Cahill, Woodinville, WA (US)

(72) Inventors: John Thornton, Kirkland, WA (US); Jason Cahill, Woodinville, WA (US)

(73) Assignee: MICROSOFT CORPORATION, Redmond, WA (US)

(21) Appl. No.: 13/432,909

(22) Filed: Mar. 28, 2012

(51) Int. Cl. G06F 17/00

(52) U.S. Cl. 463/42

(57) ABSTRACT

A game interface is presented at a plurality of client devices during an early phase of a synchronized gaming schedule shared among the client devices. An application program residing at each of the client devices generates and presents, during an intermediate phase of the synchronized gaming schedule following the early phase, an individual results summary. Individual results information is received from each client device over the communications network indicating a comparison of one or more puzzle-submissions by a player of that client device to the one or more puzzle-answers of the answer key. The individual results information received from each of the client devices is aggregated to obtain aggregated results information during the intermediate phase. The aggregated results information is transmitted to each of the client devices over the communications network for presentation at the client devices during a late phase of the synchronized gaming schedule.

### BACKGROUND

People enjoy word-puzzles in various forms. Some word-puzzles require players to form words from a collection of letters. At times, clues may be provided to players during game play to guide them toward providing suitable word-answers. New word-puzzles continue to be created in an attempt to provide players with an on-going, enjoyable, and challenging gaming experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A game interface is presented at a plurality of client devices during an early phase of a synchronized gaming schedule shared among the client devices. An application program residing at each of the client devices generates and presents, during an intermediate phase of the synchronized gaming schedule following the early phase, an individual results summary. Individual results information is received from each client device over the communications network indicating a comparison of one or more puzzle-submissions by a player of that client device to the one or more puzzle-answers of the answer key. The individual results information received from each of the client devices is aggregated to obtain aggregated results information during the intermediate phase. The aggregated results information is transmitted to each of the client devices over the communications network for presentation at the client devices during a late phase of the synchronized gaming schedule.

### BRIEF DESCRIPTION OF THE DRAWINGS

FIG. 1 shows an example game interface.

FIG. 2 shows an example graphical user interface presenting an example individual results summary.

FIG. 3 shows an example graphical user interface presenting an example real-time leader board.

FIG. 4 is a flow diagram depicting an example method for phased game play within a synchronized gaming schedule.

FIG. 5 is a flow diagram depicting an example method for constructing a game interface.

FIG. 6 is a flow diagram depicting an example method for identifying word-commonness and using word-commonness in the context of a word game or a computer program.

FIG. 7 shows an example graphical user interface of a spell checker program.

FIG. 8 shows an example graphical user interface of a word completion program.

FIG. 9 is a schematic diagram depicting an example computing system.

FIG. 10 is a schematic diagram depicting a network of computing devices.

FIG. 11 shows a list of letters and diagrams, each with an example letter-commonness score and frequency.

### DETAILED DESCRIPTION

Creating on-going, enjoyable, and challenging game word-puzzles presents a number of significant challenges. These challenges may include accommodating players having diverse skill levels, avoiding undo repetition of game elements within individual games or between games, maintaining conformance of the game to a stated theme, generating games within a suitable time frame and format for presentation to players, and creating games within the confines of a game interface of limited size that is suitable for presentation via a hand-held mobile electronic device, to name just a few examples.

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included herein are schematic and generally not drawn to scale. Rather, the various drawing scales, aspect ratios, and numbers of components shown in the figures may be purposely distorted to make certain features or relationships easier to see.

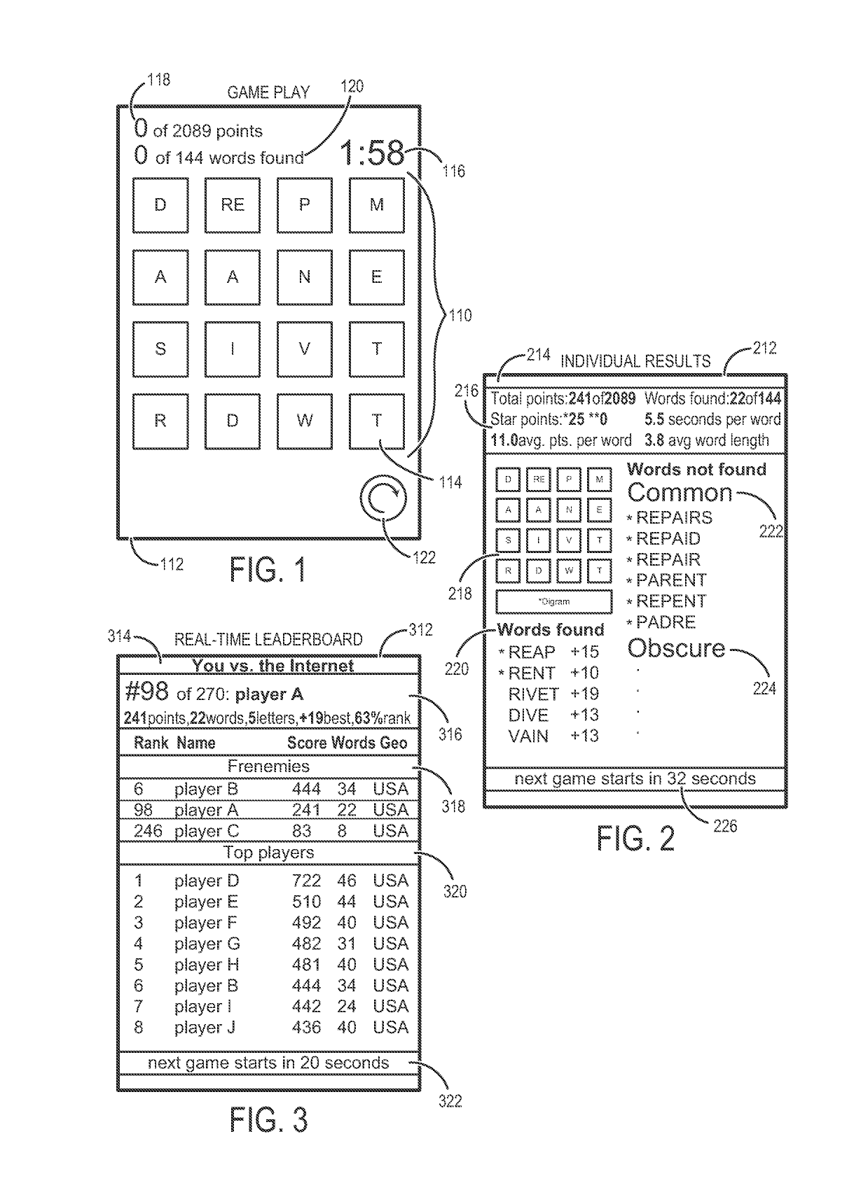

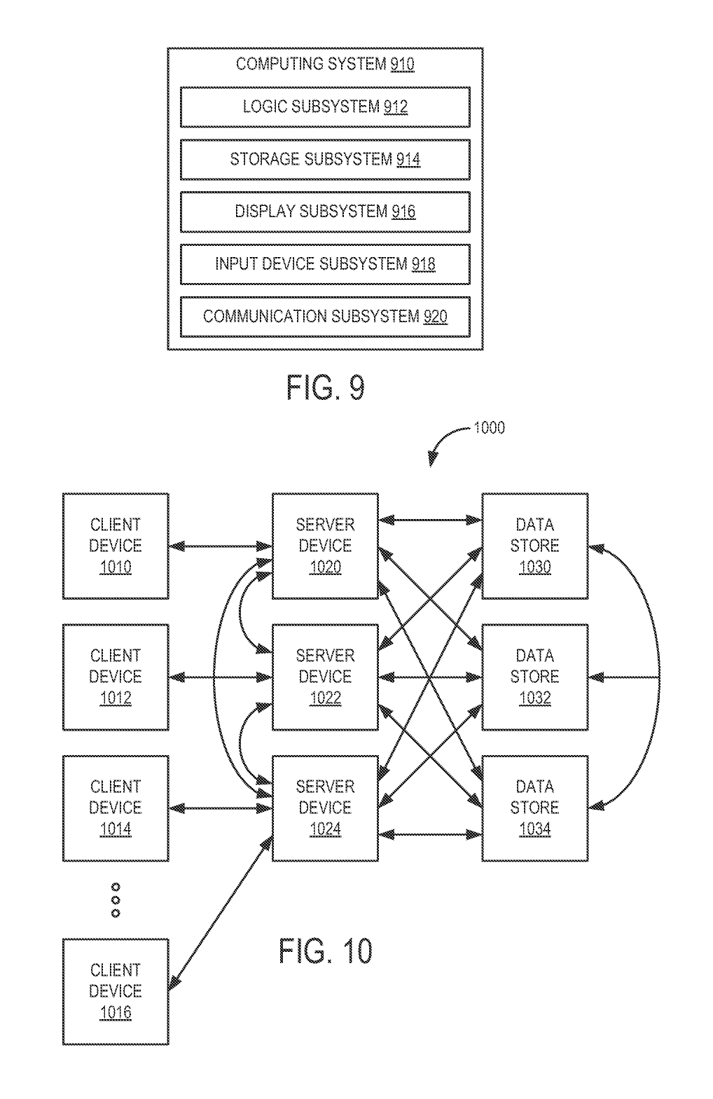

FIG. 1 shows an example game interface 110. Game interface 110 may be presented to players (e.g., human users) via a graphical user interface (GUI) 112 during a game play phase by a suitable computing device, such as a mobile telecommunications device or smart phone. Aspects of one such non-limiting computing system are described below with reference to computing system 910 of FIG. 9.

A goal of the game, for example, may be for players to identify groupings and/or sequences of game-objects located within the game interface. As one example, game-objects may include letters of an alphabetic system that may be grouped in a sequence by players to form words of a language. This particular type of game may be referred to as a word-game or a word-puzzle. Game-objects within a word-game or word-puzzle may be referred to as word-game-objects.

While described in the context of a graphical user interface, it will be understood that game interface 110 may be presented to players in other suitable formats or take other suitable forms. For example, game interface 110 may take the form of a tangible board game product having physical game elements. Accordingly, an electronic gaming environment is merely one way in which a game interface, such as game interface 110, may be deployed to players.

Game interface 110 may include a plurality of game-object locations. In this particular example, game interface 110 includes sixteen (16) game-object locations forming a four-by-four (4×4) rectangular matrix of game-object locations. Game interface 110 may be limited in size to sixteen game-object locations or another suitable number of game-object locations so that game interface 110 is suitable for presentation via a hand-held mobile electronic device. However, a game interface may include less than sixteen or greater than sixteen game-object locations, and may have a different arrangement from the rectangular matrix depicted in FIG. 1.

Each game-object location may be assigned a corresponding game-object. Game-objects may take a variety of different forms. For example, a game-object may include a letter of an alphabetic system, a combination of two or more letters (i.e., a polygram), a graphical symbol (e.g., iconic symbols, or Kanji, Kana, Hiragana, Katakana, etc. of the Japanese and/or Chinese written languages, or glyphs, etc.) a pictorial representation, a video or dynamic animation, etc.

In FIG. 1, an example game-object 114 in the lowest and farthest right game-object location of game interface 110 includes the letter “T”. Other game-objects assigned to corresponding game-object locations include, for example, the letters “D”, “A”, “S”, and “R” from top to bottom in a left-hand vertical column of game interface 110. The second-to-the-left vertical column of game-object locations are assigned from top to bottom game-objects that include the letters “RE” as an individual game-object (i.e., a diagram type of polygram), “A”, “I”, and “D”. The second-to-the-right vertical column of game-object locations are assigned from top to bottom game-objects that include the letters “P”, “N”, “V”, and “W”. The right-hand vertical column of game-object locations are assigned from top to bottom game-objects that include the letters “M”, “E”, “T”, and “T”. It is to be understood that the illustrated game-objects are non-limiting. A different set of game-objects can be assigned to the various game-object locations for each different puzzle, thus providing players with new challenges.

In at least some implementations, a rule of the game may require, for example, that words can be formed from a series of two or more letters only if those letters form a chain of adjacent game-object locations. In one example, a first game-object may be considered adjacent to a second game-object if the first game-object is located beside (left-right or up-down) or at a diagonal to the second game-object. For example, in game interface 110, the game-object location corresponding to the letter “I” is adjacent to (beginning at the twelve-o'clock position and moving clockwise) the letters “A”, “N”, “V”, “W”, “D”, “R”, “S”, and “A”.

In game interface 110, different combinations of adjacent word-game-objects form puzzle-answer words. A number of words may be formed from the game-objects of game interface 110 according to application of the above rule. As one example, the word “PAID” may be formed from the game-object corresponding to the letter “P”, the game-object corresponding to the letter “A” located at a diagonal to the letter “P”, and the game-objects located below the letter “A” in the same vertical column corresponding to the letters “I” and “D”. Hence, in the case of the word “PAID”, all letters of the word form a chain of adjacent game-objects having the same relative order or sequence within the chain as the letters within the word.

As another example, a polygram game-object such as the diagram game-object “RE” within game interface 110 may form the word “REPAIR” along with the letter “P” located to the right of the “RE” diagram, the letter “A” located at a diagonal to the letter “P”, the letter “I” located below the letter “A” in the same vertical column, and the letter “R” located at a diagonal to the letter “I”. A diagram game-object refers to a type of polygram game-object that contains two letters.

Other types of polygram game-objects may include trigram game-objects that contain three letters. Polygram game-objects having four or more letters, entire words, or word segments may be assigned to and present within a game interface. A game interface may include any suitable number of polygrams. For example, a game interface having a 4×4 matrix of game-object locations may have zero, one, two, three, four, or more polygrams. The inclusion of polygram game-objects within a game interface may be more or less prevalent depending on the particular language of the game interface (e.g., English, German, Arabic, etc.) or the particular theme of the game interface (e.g., medical words, geography words, sports words, colors, animals, politics, etc.). For example, polygram game-objects may be assigned to a game interface to enable players to form larger words than could otherwise be formed within the confines of a game interface having a relatively limited number of game-objects (e.g., a 4×4 matrix of game-objects). For some languages, such as German, for example, where the median word length is approximately 16 letters, the inclusion of polygrams would enable players to form larger words that are in excess of 16 letters.

Another rule of the game may require, for example, that individual letters of a polygram be used to form words in the order presented by the game-object in accordance with the particular language of the game. For example, in the English language, words are read from left to right. Hence, the diagram “RE” would also be read from left to right according to application of this rule to form words within the English language. By contrast, polygrams within languages that are read from right to left would apply the letters in an order from right to left within an individual game-object.

In at least some implementations, players may form a word or a combination of words without selecting spaces, hyphens, apostrophes, or other forms of punctuation. For example, a puzzle-submission word formed by a player that includes “TEAMWORK” (e.g., without an intermediate space) may be recognized as valid even if the puzzle-answer word is “TEAM_WORK”. As another example, a puzzle-submission word that includes “DOESNT” (e.g., without an intermediate apostrophe) may be recognized as valid even if the puzzle-answer word is “DOESN'T”. As yet another example, a puzzle-submission word that includes “TICKTOCK” (e.g., without an intermediate hyphen) may be recognized as valid even if the puzzle-answer word is “TICK-TOCK”. Puzzle-submission words having missing spaces, hyphens, apostrophes, etc. may be corrected on behalf of the player (e.g., without penalty) before or as part of a scoring process that is applied to identify valid puzzle-submissions. Puzzle-answer words may be presented to players (e.g., via an individual results summary) after conclusion of a game play phase with the spaces, apostrophes, hyphens, or other punctuation.

GUI 112 may further include a timer 116, a points indicator 118, and a words indicator 120, among other suitable game elements. Timer 116 may provide an indication of a relative amount of time remaining in a game play phase for a game interface presented via GUI 112. As one example, the game play phase may last for a period of 2 minutes (or other suitable time period), whereby timer 116 counts upward or downward over the 2-minute period.

Points indicator 118 may provide an indication of the current points earned by a player by forming groupings (e.g., valid puzzle-submissions of words or sentences) from game-objects within the game interface. Points indicator 118 may further provide an indication of a total number of points available in the current game interface.

Words indicator 120 may provide an indication of the current number of words formed by the player within the game interface. Words indicator 120 may further provide an indication of the total number of words that can be formed from the game-objects of the current game interface. Words that can be formed from the game-objects may be referred to as puzzle-answers. The total number of points and the total number of words available within a particular game interface (e.g., puzzle-answers) may vary depending on the game-object arrangement within the game interface, including the type of game-objects and the relative location of those game-objects.

During the game play phase, a player may attempt to form as many groupings of game-objects as possible in conformance with the rules of the game. Groupings of game-objects formed by the player may be referred to as puzzle-submissions. In one example, a game interface, such as example game interface 110, may be presented to a number of players at the same time via their respective device. These players may compete against each other with respect to a common game interface shared by all players during the game play phase.

In at least some implementations, a player may form or identify groupings of word-game-objects by selecting the word-game-objects from within the game interface. As one example, the player may select or otherwise identify a word-game-object by touching, tapping, or circling the word-game-object via a touch-screen display, by navigating a pointer device (e.g., a computer mouse) to and initiating a selection command at the word-game-object, by typing a letter or a set of letters of the word-game-object into a physical keyboard or virtual touch-screen keyboard, or by speaking the letter or set of letters of the word-game-object into a microphone. As another example, the player may select or otherwise identify a puzzle-submission word formed by one or more word-game-objects by touching, tapping, or circling the one or more word-game-objects via a touch-screen display, by navigating a pointer device to and initiating a selection command at the one or more word-game-objects, by typing the letters or the set of letters of the one or more word-game-objects into a physical keyboard or virtual touch-screen keyboard, or by speaking the puzzle-submission word or individual letters of the one or more word-game-objects into a microphone. The word-game-objects forming a puzzle-submission word may be selected or otherwise identified by the player in a sequence in which the word-game-objects form the puzzle-submission word. Submission of an individual word-game-object or a puzzle-submission word may be confirmed, in at least some implementations, by a player initiating a selection command, such as by selecting a confirmation button or other suitable control element, by pressing a return key on a physical or virtual keyboard, by clicking a selector button on a pointer device (e.g., a left-click button on a computer mouse), or by speaking a particular word into a microphone.

A puzzle-submission may be valid or correct if the puzzle-submission is also a puzzle-answer. Conversely, a puzzle-submission may be invalid or incorrect if the puzzle-submission is not also a puzzle-answer. Under some game rules, a puzzle-submission may be considered invalid or incorrect even if the puzzle-submission (e.g., a puzzle-submission word) is a real word of the language, but not a puzzle-answer (e.g., a puzzle-answer word). GUI 112 may further include a control element 122 that enables a player to selectively end the game play phase prematurely before expiration of timer 116. Upon conclusion of the game play phase, the player may be presented with a summary of results.

FIG. 2 shows an example graphical user interface 212 presenting an example of an individual results summary 214 for an individual player. GUI 212 may be presented to a player during an individual results phase following a game play phase. The GUI 212 may be presented to the player via the same device that presented GUI 112 to the player. GUI 212 may effectively replace GUI 112 after the game play phase has ended.

Individual results summary 214 may include any suitable information indicating a player's performance during the previous game play phase. A non-limiting example of this information is depicted at 216, including: a total number of points earned by the player (e.g., a game-score value), a total number of available points that could be earned, a total number of words identified by the player (e.g., the number of valid puzzle-submission words), a total number of words available for identification (e.g., the number of puzzle-answer words), an average amount of time spent by the player identifying a word (e.g., average time per valid puzzle-submission word), an average number of points per word identified by the player (e.g., average points per valid puzzle-submission word), an average length per grouping (e.g., valid puzzle-submission word) identified by the player (e.g., measured in terms of the number of letters, characters, game-objects, etc.), the number of special groupings (e.g., valid puzzle-submission words) identified by the player or special points earned by the player.

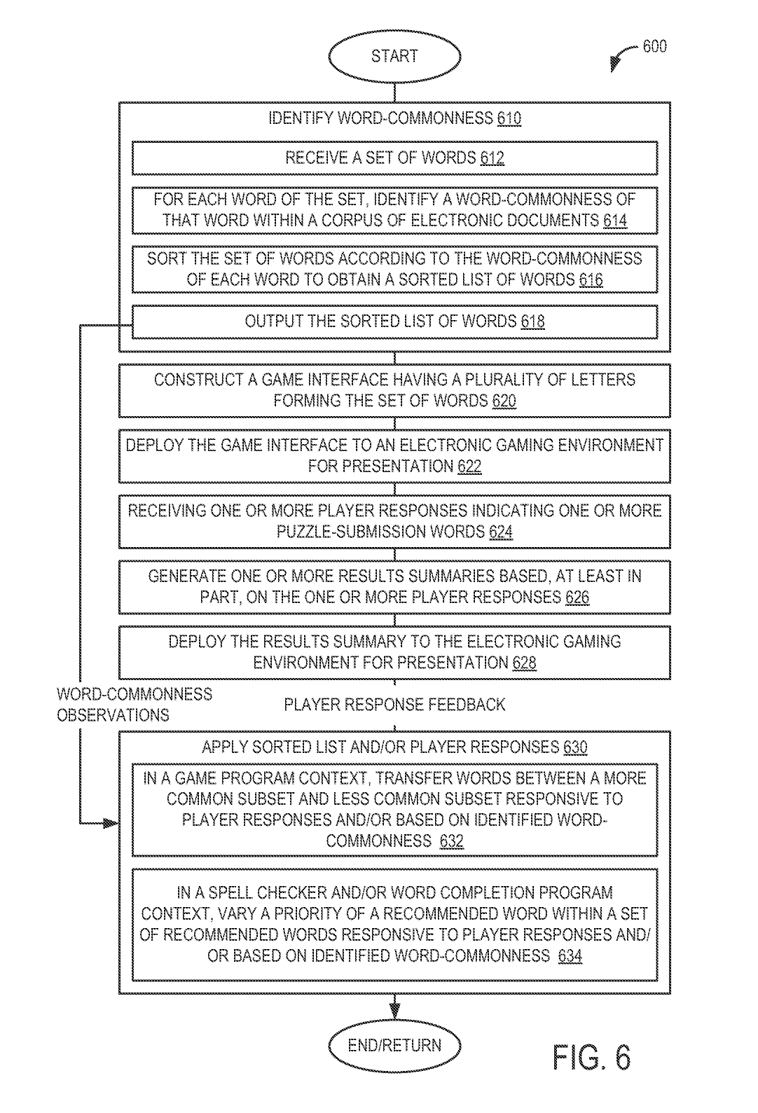

Individual results summary 214 may further include a visual representation 218 of the game interface presented during the game play phase, a list of words 220 identified by the player during the game play phase (e.g., valid puzzle-submission words), and a complete or partial list of words (indicated at 222 and 224) not identified by the player during the game play phase (e.g., puzzle-answer words not present in the puzzle-submission words). An individual results summary may categorize puzzle-answer words found or not found by the player into a more common subset of words (referred to as common words) and a less common subset of words (referred to as obscure words). For example, individual results summary 214 may indicate a list of common words 222 not identified by the player within the game interface and a list of obscure words 224 not identified by the player within the game interface. Further discussion of word-commonness is provided with reference to FIG. 6.

In at least some implementations, the visual representation of the game interface within the individual results summary may be visually augmented (e.g., through highlighting, bolding, color variation, icons, symbols, etc.) to demonstrate the location of a particular puzzle-answer word within the game interface. For example, in response to a player selecting a puzzle-answer word from a list, the location of that puzzle-answer word may be indicated by highlighting the word-game-objects forming that word at visual representation 218 of the game interface. This feature may provide a player with visual feedback as to the location of an individual puzzle-answer word within the game interface.

The words presented in the individual results summary may be arranged according to any suitable order, including by point value, alphabetical order, or order by which the words were identified by the player during the game play phase. These words may be presented with a corresponding point value awarded to a player for identifying the word. The total number of points awarded to the player during an individual game play phase (e.g., a game round) may be referred to as the game-score value for the game round.

Some words may represent special words within a game. For example, words formed from a polygram game-object (e.g., the diagram “RE”) may represent special words that may be distinguished visually with a star, highlighting, bolding, color difference, or other suitable visual indicator in the individual results summary. Special words may be ordered differently than (e.g., before or after) other words in lists presented by the individual results summary, or may be organized into special and non-special word lists.

GUI 212 may include a timer 226 that provides an indication of a relative amount of time remaining until another game play phase begins. For example, timer 226 depicted in FIG. 2 may count downward to the start of the next game play phase (e.g., the next game round).

FIG. 3 shows an example graphical user interface 312 presenting an example real-time leader board. GUI 312 may be presented to a player (e.g., having an identity: “Player A”) during a real-time leader board phase following the individual results phase. In contrast to the individual results summary of FIG. 2 that includes results that are specific to an individual player, the real-time leader board further indicates the results for other players with respect to the same game interface of the previous game play phase. The GUI 312 may be presented to the player via the same device that presented GUIs 112 and 212 to the player. As one example, GUI 312 may effectively replace GUI 212 after the individual results phase has ended. As another example, GUI 312 may be presented alongside GUI 212 via the same device. In at least some implementations, a user may dismiss or minimize one of GUI 212 or GUI 312 while viewing another of GUI 212 or GUI 312. As one example, a user may navigate between GUI 312 and GUI 212 at least until another game play phase begins.

In FIG. 3, real-time leader board 314 includes a ranking of a player (e.g., “Player A”) relative to other players (e.g., rank number 98 out of 270 players). Real-time leader board 314 may include a list of the top players 320 with respect to the same game interface, including an indication of a game score-value, valid puzzle-submission words, geographic locations of those players, and player identities. Real-time leader board 314 may include a list of one or more socially-connected players 318 (e.g., Player B and Player C) that are followed by the player (e.g., Player A). For example, in FIG. 3, the term “Frenemies” is used as a header to describe an example list of socially-connected players that are followed by a player. Real-time leader board 314 may further include player comparison statistics 316, including: an indication of a game-score value earned by the player, a total number of puzzle-submission words identified by the player, total letters or game-objects used by the player to form the puzzle-submission words, the player's best score (e.g., highest game-score value) or average score, and the player's rank as a percentage of other players.

GUI 312 may include a timer 322 that provides an indication of a relative amount of time remaining until another game play phase begins (e.g., the next game round). For example, timer 322 depicted in FIG. 3 may count downward to the start of the next game play phase. In at least some implementations, timer 322 of the real-time leader board and timer 226 of the individual results summary may provide players with a common and seamless indication of time remaining until the next game play phase across GUIs 212 and 312. For example, upon expiration of timer 226 and/or timer 322, another game play phase may begin as a new game round with a new game interface having a different game-object arrangement. As a non-limiting example, the individual results phase and the real-time leader board phase may have combined duration of 45 seconds. Accordingly, game play may be phased within a synchronized gaming schedule across multiple players having a total duration of 2 minutes and 45 seconds, in at least one implementation. Within this synchronized game schedule, each player's game play phase, individual results phase, and/or real-time leader board phase may be synchronized with the other players.

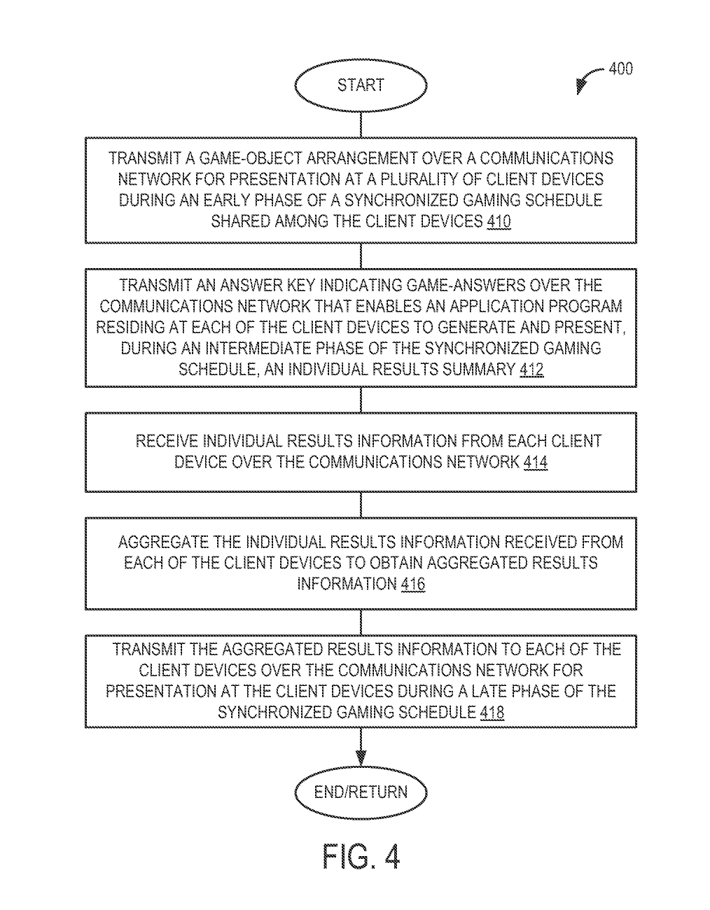

FIG. 4 is a flow diagram depicting an example method 400 for phased game play within a synchronized gaming schedule. As previously described with reference to FIGS. 1-3, a gaming environment may have a number of phases. A game play phase (e.g., an early phase) may include presentation of a game interface to one or more players. These players may interact with the game interface during the game play phase. An individual results phase (e.g., an intermediate phase) may follow the game play phase during which individual result summaries may be presented to individual players that are specific to those players. A real-time leader board phase may follow the individual results phase (e.g., a late phase) during which real-time results summaries in the form of a real-time leader board may be presented to the players. The real-time leader board may indicate results with respect to a number of different players for a given game interface.

At 410, a game-object arrangement defining a game interface may be transmitted over a communications network for presentation at a plurality of client devices. The game-object arrangement may be transmitted during one or more of an early phase (e.g., during a game play phase) of a synchronized gaming schedule, and/or an intermediate phase and/or late phase during which results are presented to the players.

The game-object arrangement may be transmitted to one or more client devices over a communications network by a server device responsive to requests initiated by the one or more client devices, or may be pushed to the one or more client devices by the server device without necessarily receiving such requests. A plurality of game-object arrangements may be transmitted as a group over the communications network to each client device, or a game-object may be transmitted individually to each client device for each game round. Transmission of multiple game-object arrangements may be used to reduce interruptions to game play at a client device due to a loss of access or reduced access to a communications network.

In at least some implementations, synchronization information may be transmitted by a server device to a plurality of client devices over a communications network to enable each client device to maintain or increase synchronization among client devices according to the synchronized gaming schedule. The synchronization information may include a time stamp, a clock time, a synchronization signal, or other suitable synchronization information.

At 412, an answer key indicating one or more puzzle-answers (e.g., puzzle-answer words) for the game-object arrangement may be transmitted over the communications network. The answer key may enable an application program residing at each of the client devices to generate and present, during an intermediate phase of the synchronized gaming schedule following the early phase, an individual results summary. The individual results summary for a client device may be based on a comparison of one or more puzzle-submissions supplied by a player to the one or more puzzle-answers of the answer key. A non-limiting example of an individual results summary is depicted in FIG. 2.

An answer key may indicate one or more puzzle-answers for a game interface, a point value of each of those puzzle-answers, a word-commonness of each of those puzzle-answers, or other suitable information. The answer key may accompany a game-object arrangement transmitted to the client devices, or may be transmitted separately from the game-object arrangement during the same or different phase of the synchronized gaming schedule. Multiple answer keys may be transmitted with multiple game-object arrangements. An answer key for a particular game-object arrangement may be transmitted with a different game-object arrangement for a subsequent game round in some examples.

At 414, individual results information may be received from each client device over the communications network. For each client device, the individual results information may indicate the comparison of the one or more puzzle-submissions supplied by the player of that client device to the one or more puzzle-answers of the answer key. The individual results information received from each client device may indicate a game-score value and an identity of that client device or player of that client device. The game-score value may be based, at least in part, on the comparison of the one or more puzzle-submissions to the one or more puzzle-answers.

In at least some implementations, an individual result summary may indicate results obtained from a plurality of game rounds for a player. For example, an application program at the client device may transmit an individual results summary indicating the results of two, three, four, or more game rounds for a player. Note that in some implementations, at least some processing of individual results information may be performed at a server device remote from the client device. As one example, the server device may perform a comparison of the answer key to the puzzle-submission words supplied by the player to obtain the individual results information. In this example, the server device may transmit an individual results summary to the client device for presentation that is based on the individual results information obtained by the server device.

In at least some implementations, the individual results information may be received as an encrypted value from each client. For example, the application program at each client device may encrypt the individual results information transmitted by that client device to obtain the encrypted value. The encrypted value may take the form of a hashed value. As one example, the application program may encrypt the individual results information by hashing the individual results information with one or more of a player identifier, application program identifier, client device identifier, etc. The individual results may be hashed in a multi-step process in which, for example, the individual results information is first hashed with the player identifier or client device identifier, and then hashed again with the application program identifier.

It will be appreciated that other suitable encryption techniques may be applied at the application layer to secure the individual results information. Encryption techniques may be applied at the transport layer and/or by an operating system of the client device in addition to or as an alternative to the encryption techniques applied by the application program. Another encryption technique that may be applied includes obfuscation, which refers to the encoding of information before that information is hashed. The individual results information may be encoded using any suitable codec to provide obfuscation type encryption. Yet another encryption technique includes the addition of padding or dummy information to the individual results information to obtain an over-specified value. Again, these and other encryption techniques may be used alone or in combination with respect to the transmission of results information between each client device and a server device.

The individual results information received from each client device may be validated (e.g., decrypted at a server device) based, at least in part, on the encrypted value received for that client device. For example, the individual results information received from a particular client device may be validated using a shared secret for that client device, such as the player identifier, application program identifier, client device identifier, etc. At 416, the individual results information received from each of the client devices may be aggregated or otherwise combined, during the intermediate phase, to obtain aggregated results information. As one example, the individual results information may be aggregated by identifying one or more top game-score values of the plurality of client devices. The aggregated results information transmitted to each of the client devices may indicate the one or more top game-score values among the plurality of client devices.

For each client device, if the individual results information is validated for that client device, the individual results information received from that client device may be aggregated into the aggregated results information. However, if the individual results information is not validated for that client device, the individual results information received from that client device may be withheld from aggregation with the aggregated results information transmitted to one or more other client devices. Instead, the individual results information received from that client device may be aggregated into the aggregated results information transmitted to only that particular client device. As such, the aggregated results information transmitted to that particular client device may differ from the aggregated results information transmitted to the other client devices.

In some scenarios, multiple client devices may submit individual results information for the same player (e.g., indicating the same player identifier as the source). In this case, a best score (or alternatively a worst score) of these submissions may be attributed to the player, and other scores may be discarded. Again, if individual results information received from particular client device is not validated, the individual results information received from that client device may be withheld from aggregation with the aggregated results information.

By withholding the individual results information that has not been validated from the aggregated results information shared with other players and/or client devices, the dissemination of that individual results information may be confined to the originating player and/or client device. Validation of individual results information may be used to limit or reduce the impact of cheating, or late or unofficial results on the aggregated results information. As one example, un-validated individual results information withheld from the aggregated results information may result in a player not being part of the player rankings that are presented to other players for that game round.

At 418, the aggregated results information may be transmitted to each of the client devices over the communications network. The aggregated results information may be presented at the client devices, for example, during a late phase of the synchronized gaming schedule. The aggregated results information may be transmitted alone or in combination with one or more game-object arrangements and/or answer keys for subsequent game rounds. The aggregated results information may be transmitted on a per game round basis or may be transmitted in combination for a number of game rounds.

The aggregated results information transmitted to each client device enables the application program residing at that client device to present an aggregated results summary. A non-limiting example of the aggregate results summary includes the real-time leader board 314 of FIG. 3. The aggregated results summary may include an indication of a relative ranking of a player of that client device (e.g., based on the individual results information received from that client device) relative to other players (e.g., based on the individual results information received from the other client devices). The aggregated results information may further indicate the identity (e.g., client identity or player identity) attributed to each of the one or more top game-score values and/or game-score values within a prescribed range (e.g., 20 ranks above and/or 20 ranks below) of that player's game-score value.

Aggregated results information, such as in the form of a leader board, may resolve ties between players having the same game score or game performance by identifying those players as having the same rank. For example, rankings may accommodate two players having a first place rank. A player that follows these two players in rank may be identified as having a third place rank so that a numeric rank associated with each player represents a number of players that have a higher rank than that player. Rankings may be globally applied across a pool of players and/or players may be grouped into a number of divisions in which players are ranked within their respective division. For example, a player may be identified as having a global rank of 1000th place overall, while also being identified as having a first place rank within a particular division. Divisions may be based on skill level, age, geographic location, or other suitable attribute of the players.

The aggregated results information transmitted to a client device may further indicate a relative ranking of one or more socially-connected players. For example, the aggregated results information received by a player may indicate a relative ranking of players that are socially-connected to that player.

As previously described with reference to FIG. 3, a player may follow one or more other players. For example, a player may identify one or more other players to follow across one or more gaming sessions. In at least some implementations, two or more players may be socially-connected with each other via a service of an information network. As one example, the service may take the form of a gaming service accessible by players to play one or more of the puzzle-games described herein. As another example, the service may take the form of a social network service. A service may support player profiles in which a player may identify other players that are socially connected to that player. Players may be identified and distinguished from other players, in one example, by a player identity. A first player may follow a second player by indicating an identity of the second player in a follow-request transmitted by a client device operated by the first player to the service over a communications network. In at least some implementations, the second player may be presented with the option of approving or denying the follow-request before the first player may be socially-connected to the second player by the service. However, approval by players identified by follow-requests is not required in some implementations. In the context of a gaming service, a player may be presented with options that enable that player to follow all players socially-connected by that player or a subset of those socially-connected players within an individual game round, an individual gaming session having multiple game rounds, or for all subsequent gaming sessions.

In accordance with method 400, an application program (or other suitable instruction set) executed at a client device may be configured to receive a game-object arrangement defining a game interface over a communications network at the client device from a server system. As one example, the application program may include or take the form of a general purpose application program such as a web browser that enables a player to interact with a server-side game that is played through or at the web browser. As another example, the application program may include or take the form of a specific purpose game-type application program (e.g., game program) executed at the client device.

The application program may be configured to present the game interface defined by the game-object arrangement, and receive one or more puzzle-submission words supplied by a player during the early phase. The application program may be further configured to receive an answer key indicating one or more puzzle-answers over the communications network at the client device from the server system. During an intermediate phase of the synchronized gaming schedule following the early phase, the application program may be configured to generate an individual results summary based on a comparison of the one or more puzzle-submissions words to the puzzle-answer words of the answer key, and transmit individual results information over the communications network to the server system indicating the comparison of the one or more puzzle-submission words to the one or more puzzle-answer words of the answer key. The application program may be configured to receive aggregated results information over the communications network at the client device from the server system, and present the aggregated results information during a late phase following the intermediate phase.

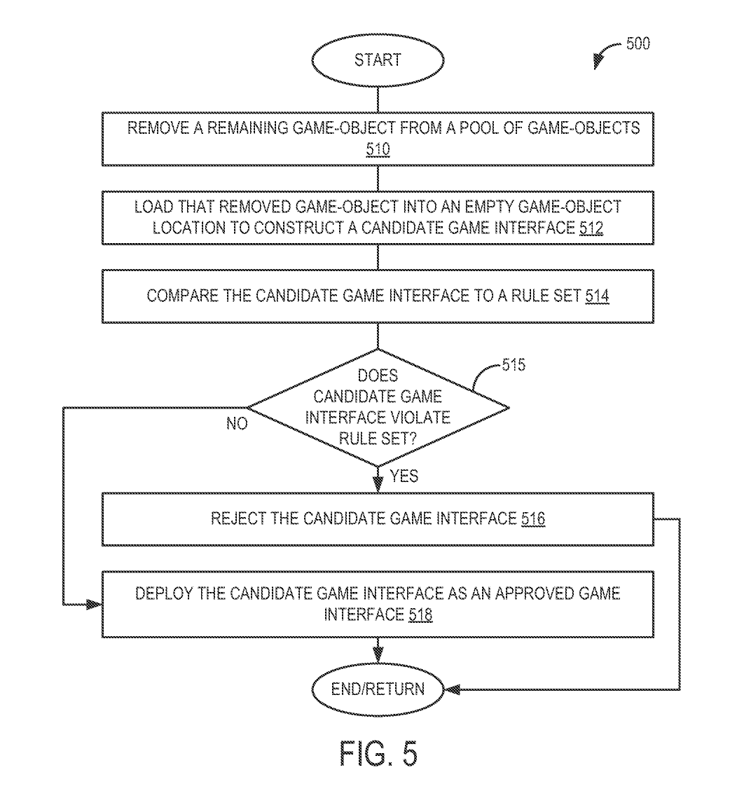

FIG. 5 is a flow diagram depicting an example method 500 for constructing a game interface. As a non-limiting example, the game interface may take the form of previously described game interface 110 of FIG. 1. For example, the game interface may include a plurality of game-object locations that are assigned corresponding game-objects.

At 510, the method may include removing a remaining game-object from a pool of game-objects. As previously described, each of the game-objects may include a letter, a combination of two or more letters, or other suitable graphical element. The pool of game-objects may be initially defined by analyzing a corpus of documents to identify a frequency or a letter-commonness of letters or combination of letters (e.g., polygrams) within the corpus. Further discussion of letter-commonness is provided with reference to FIG. 6.

The pool of game-objects may include any suitable number of game-objects, and may provide a representation of the frequency or letter-commonness of letters of those game-objects within an analyzed corpus of documents. For example, the pool of game-objects may include a single game-object for each letter of an alphabetic system (e.g., 26 game-objects in the English alphabet) or multiple game-objects for some or all of the letters of an alphabetic system (e.g., 30 game-objects including the letter “A” and only 1 game-object including the letter “X”). Accordingly, the pool of game-objects may include tens, hundreds, thousands, millions, or more game-objects with each game-object including a corresponding letter, group of letters, or other suitable graphical element.

At 512, the method may include loading or assigning the removed game-object into an empty game-object location to construct a candidate game interface. In at least some implementations, the removed game-object may be selected randomly from the pool of game-objects. As a non-limiting example, a game-object that includes the letter “P” may be loaded into an empty game-object location within a matrix (e.g., a rectangular 4×4 matrix) of game-object locations, as depicted in FIG. 1. Game-object locations of a game interface may initially be empty before being loaded with game-objects.

The method at 510 and 512 may be performed for each of a plurality of empty game-object locations in a game interface so that the game interface is fully loaded with game-objects. A game interface that is partially or fully loaded with game-objects may be defined by its game-object arrangement, which includes a game-object value for each game-object location. The game-object value may correspond to any suitable information presented by a game-object, including a letter, combination of letters, graphical element, etc.

In at least some implementations, removal of a game-object from the pool of game-objects may preclude that game-object from again being assigned to a game-object location within the same game interface. However, as previously discussed, multiple game-objects that include the same letter, combination of letters, or graphical element may be present within the pool of game elements. As such, for example, a first “A” game-object can be loaded into an empty game-object location and a second “A” game-object, different than the first “A” game-object can be loaded into a different empty game-object location. Once loaded, the pool of game-objects will include two fewer “A” game-objects that could be loaded into other empty game-object locations. The method at 510 and 512 may be performed multiple times to generate a plurality of different candidate game interfaces that are fully loaded with game-objects.

In at least some implementations, the method at 510 and 512 may include randomly selecting from the pool of game-objects and/or randomly assigning at least some or all of the game-objects to corresponding game-object locations within a candidate game interface without necessarily removing the selected game-objects from the pool. Hence, a game-object may be selected and assigned multiple times for a given game interface, at least within some implementations.

In at least some implementations, the method at 510 and 512 may include programmatically selecting and assigning a subset of the game-objects to corresponding game-object locations within the candidate game interface, and randomly assigning other game-objects to remaining corresponding game-object locations within the candidate game interface not yet occupied by the subset. This programmatic approach may be used, for example, to form a set of themed words from a defined pool of themed words, or to ensure relative placement of game-objects adjacent to (or alternatively not adjacent to) other game-objects in accordance with a rule, such as a rule ensuring the letter “Q” is always adjacent to the letter “U”.

At 514, the method may include comparing the one or more candidate game interfaces to a rule set. A rule set may define one or more conditions that are to be satisfied by a candidate game interface before the candidate game interface is deployed as an approved game interface. Any suitable rule set may be used to filter a candidate game interface as will be described by way of several non-limiting examples. If at 515, the candidate game interface violates the rule set, then the method at 516 may include rejecting the candidate game interface. However, if the candidate game interface does not violate the rule set, then the method at 518 may include deploying the candidate game interface to a gaming environment as an approved game interface. Approved game interfaces may be presented to players during game play.

In at least some implementations, deploying the approved game interface to the gaming environment may include initiating transmission of a game-object arrangement of the approved game interface over a communications network directed to one or more client devices for presentation of the approved game interface to one or more players. In other implementations, deploying the approved game interface may include presenting the approved game interface locally via a display subsystem. In still other implementations, deploying the approved game interface may include providing a collection of approved game interfaces to a game provider that serves the game interfaces to players.

The gaming environment may take various forms, including an individual client device with which a player interacts, a client device with which the player interacts within a computing system having a number of other client devices, or a tangible board game product having physical game-objects that may be manually arranged in the appropriate game-object locations by a human operator in accordance with the game-object arrangement of an approved game interface.

A rule set may include one or more rules that are actively applied to determine whether a candidate game interface should be rejected or deployed as an approved game interface. A rule set may include an intra-game rule set and/or an inter-game rule set. A rule of an intra-game rule set may define one or more conditions to be satisfied by parameters existing within a candidate game interface. A rule of an inter-game rule set may define one or more conditions to be satisfied by parameters existing between a candidate game interface and at least one other game interface. In at least some implementations, if a candidate game interface violates a rule of either an intra-game rule set or an inter-game rule set, the method at 516 may include rejecting the candidate game interface. Conversely, with this implementation, if a candidate game interface does not violate a rule of either the intra-game rule set or the inter-game rule set, the method at 518 may include deploying the candidate game interface as an approved game interface.

As a first example, a rule of an intra-game rule set may define a threshold number of puzzle-answer words that include a particular letter and/or a particular game-object of the candidate game-interface. As a non-limiting example, the threshold number of words may correspond to three (3) words. Hence, to satisfy this example rule, at least one letter of a game-object of the candidate game interface must be a member of three or more words that can be formed by game-objects of the candidate game interface. This example rule may define a threshold number of words (e.g., a minimum threshold) to be formed by some (e.g. one, two, three or more) or all game-objects of the candidate game interface. This example rule may be used to ensure that some or all of the game-objects are playable within a threshold number of combinations (e.g., puzzle-answer words).

As a second example, a rule of an intra-game rule set may define a threshold number of common words of which each game-object (or some of the game-objects) is a member. As non-limiting examples, the threshold number of common words may correspond to one, two, three, or more common words for each game-object. Hence, to satisfy rule, all game-objects of the candidate game interface must be a member of at least one, two, three, or more common words. Note that the threshold number of common words may be less than or equal to the threshold number of words described in the first example. Alternatively or additionally, a rule may define a threshold number of obscure words of which each game-object (or some of the game-objects) is a member. The threshold number of obscure words may be less than or equal to the threshold number of words described in the first example. These example rules may be used to ensure that some or all of the game-objects are playable within a threshold number of common and/or obscure words so that the game interface is enjoyable to players of different skill levels. Further discussion of word-commonness is available with reference to FIG. 6.

As a third example, a rule of an intra-game rule set may define at least a threshold number of polygram words that include a polygram game-object. The threshold number of polygram words may be greater than, less than, or equal to the threshold number of words of the first example or the threshold number of common or obscure words of the second example.

As a fourth example, a rule of an intra-game rule set may define at least one pair of game-objects that have a pre-established game-object location relationship relative to each other within the candidate game interface. An illustrative example includes the letters “Q” and “U” within the English language, which form the majority of “QU” word combinations. For example, if a game-object of the pair of game-objects is not adjacent to the other game-object of the pair, this rule may be violated. As another example, a rule of the intra-game rule set may preclude two polygram game-objects from being located adjacent to each other.

As a fifth example, a rule of an intra-game rule set may define a minimum number of words (e.g., a minimum number of puzzle-answer words) and/or a maximum number of words (e.g., a maximum number of puzzle-answer words) that can be formed from game-objects of a candidate game interface. As a non-limiting example, a rule may define a maximum of 300 puzzle-answer words and a minimum of 100 puzzle-answer words. This example rule may be used to ensure that a game-object arrangement has a suitable number of game-object combinations (e.g., not too many or too few puzzle-answer words, puzzle-answer sentences, etc.). A maximum and/or minimum threshold number of words may be specific to word type (e.g., common vs. obscure). As a non-limiting example, a rule may define a minimum number of 80 common words and a maximum number of 220 obscure words. As another non-limiting example, a rule may define a maximum number of 160 common words and a minimum number of 100 obscure words.

As a sixth example, a rule of an intra-game rule set may define a minimum and/or maximum number of themed words that can be formed from game-objects of a candidate game interface. A set of themed words may form a subset of a larger set of words forming puzzle-answer words of a game interface. Themed words may be directed to any suitable theme, such as sports, current events, animals, etc. As a non-limiting example, the minimum number of themed words may correspond to six (6) themed words that can be formed within a candidate game interface. This example rule may be used to ensure that game interfaces adhere to a particular theme.

As a seventh example, a rule of an intra-game rule set may define a minimum and/or maximum number of puzzle-answer words formed from a minimum and/or maximum number of game-objects or letters of a candidate game interface. As a non-limiting example, the rule may require at least one (1) puzzle-answer word within a candidate game interface formed from six or more game-objects or letters. As another non-limiting example, the rule may require that no more than ten (10) puzzle-answer words within a candidate game interface have more than eight (8) game-objects or letters.

As an eighth example, a rule of the intra-game rule set may define a minimum and/or maximum number of polygrams game-objects within a candidate game interface. As one example, a minimum number may be (1) polygram game-object, and a maximum number may be four (4) polygram game-objects per game interface. As another example, the minimum and maximum may be zero (0) or one (1) polygram game-object per game interface. As previously discussed, the minimum and maximum number of polygram game-objects may be based on a language and/or theme of the game interface as the inclusion of polygram game-objects enable players to form larger words than could be formed from individual letters.

Turning to the inter-game rule set, an example rule of an inter-game rule set may define a threshold number or threshold proportion of puzzle-answer words formed from game-objects that are shared by a candidate game interface with one or more preceding approved game interfaces. For example, the candidate game interface may satisfy this rule if less than the threshold number or threshold proportion of the puzzle-answer words of the candidate game interface are shared with the one or more immediately preceding approved game interfaces. As a non-limiting example, a rule may define a maximum threshold overlap between game-object arrangements of two or more game interfaces as 10% of the puzzle-answer words or 20 total puzzle answer words. In at least some implementations, candidate game interfaces may be processed in a queue for which each candidate game interface may be compared to preceding approved or rejected game interfaces. These example rules of an inter-game rule set may be used to limit repetition among game interfaces and to increase variety between game interfaces.

A rule of an inter-game rule set may constrain this threshold number or threshold proportion of puzzle-answer word overlap to a specified number of preceding approved game interfaces. As a non-limiting example, this specified number may correspond to ten (10) preceding approved game interface. This threshold number or threshold proportion may change depending on how recently the approved game interface preceded the candidate game interface. For example, within a queue of game interfaces, a rule may require that no more than 10 words can be shared between adjacent (e.g., temporally or within the queue) game interfaces, no more than 20 words can be shared between game interfaces that are within five game interfaces apart from each other, and no word sharing restrictions are to be applied between game interfaces that are more than ten game interfaces apart from each other

In at least some implementations, a rule of an inter-game rule set may preclude a candidate game interface from being approved if a game-object arrangement of the candidate game interface is identical to the game-object arrangement of any preceding approved game interface. Game interfaces may be deemed to have identical game-object arrangements if a game interface is identical to another game interface after accounting for rotation of the game interface and/or mirror images of the game interface. This example rule may be used to further limit repetition among game interfaces.

A rule of an inter-game rule set may preclude approval of a candidate game interface that includes a puzzle-answer word that is present in a number of preceding approved game interfaces. As a non-limiting example, a puzzle-answer word or a particular subset of puzzle-answer words may not be present in any of the five (5) preceding approved game interfaces. As another example, an inter-game rule may prohibit reuse of long themed words. For each themed puzzle, one or more long themed words (e.g., having six or more letters) may be selected from a list of themed words and loaded into empty game-object locations of the game interface. If a valid game interface can be constructed with that themed word, then that themed word may be removed from the list of themed words. An example list of themed words may contain 150-300 words, permitting 20 themed game-interfaces for each theme category. This rule ensures that a long themed word such as “QUARTERBACKS” for the American Football themed puzzle cannot appear twice within less that a threshold number of game interfaces and/or within a threshold time period (e.g., hours, days, weeks, years, etc). Themed puzzles may be mixed with standard (e.g., non-themed) puzzles and/or polygram puzzles in a series of puzzles presented to players. These example rules may be used to further limit repetition among game interfaces.

Method 500 may be implemented to generate a plurality of candidate game interfaces, test those candidate game interfaces, reject some of those candidate game interfaces, and deploy some of those candidate game interfaces as approved game interfaces. Hence, if at least one candidate game interface of a plurality of candidate game interfaces satisfies the rule set (e.g., all rules of the rule set), then that candidate game interface may be promoted to an approved game interface. It will be appreciated that tens, hundreds, thousands, millions, or more candidate game interfaces may be rejected for each candidate game interface that is promoted to an accepted game interface and deployed to a gaming environment.

In at least some implementations, promoting a candidate game interface to an approved game interface may be performed only if the candidate game interface satisfies all rules of both the intra-game rule set and the inter-game rule set. It will be appreciated that the various example rules of an intra-game rule set and the various example rules of an inter-game rule set may be used alone or in combination with each other to obtain approved game interfaces having suitable game-object arrangements. In at least some implementations, if all rules of an intra-game rule set are satisfied by a candidate game interface, but one or more rules of an inter-game rule set are violated, that candidate game interface may be moved to a different position in a queue of candidate game interfaces to satisfy the one or more rules that were previously violated.

However, in other implementations of method 500, some candidate game interfaces may be promoted to an approved game interface and deployed to the gaming environment even if those candidate game interfaces do not necessarily satisfy all rules or any rule of the applied rule set. As a non-limiting example, less than a threshold proportion (e.g., less than 5%) of candidate game interfaces may be promoted to approved game interfaces that do not satisfy a rule of a rule set. As another non-limiting example, candidate game interfaces may be promoted to approved game interfaces if they satisfy more than 90% of the rules of a rule set or if they obtain at least a threshold level of compliance with the rule set.

FIG. 6 is a flow diagram depicting an example method 600 for identifying word-commonness and using word-commonness in the context of a word-game or a computer program such as a spell checker or word completion program. Word-commonness may be identified at 610. As one example, at 612, a set of words of a language may be received. The set of words may include some or all words of a language. For example, the set of words may include themed words. As another example, the set of words may not include proper nouns (e.g., names of people or places) of the language. As yet another example, the set of words may not include words deemed too obscure or too common. The set of words may include any suitable number of words, including tens, hundreds, thousands, millions, or more words. Some or all of the set of words may be puzzle-answers for a given game interface. In at least some implementations, the set of words may include all words of the corpus of electronic documents.

At 614, for each word of the set, a word-commonness of that word within a corpus of electronic documents may be identified. An electronic document may include an electronic digital representation of a book, a periodical, a webpage, a text representation of an audio recording, metadata associated with a media content item (e.g., a music file, an image file, a video file, etc.), or other suitable electronic document. The corpus of electronic documents may include one or more electronic documents that may take the form of one or more electronic files. For example, the corpus of electronic document may include tens, hundreds, thousands, millions, or more electronic documents.

The word-commonness identified for each word may be based, at least in part, on a frequency of that word within the corpus of electronic documents. In at least some implementations, a computer program may be applied to the corpus of electronic documents to identify a word-commonness for each word of the set. For example, the computer program may take the form of a web-crawler-type program or other suitable program that indexes the electronic documents. The computer program may count each occurrence of each word within each electronic document, for example.

For each word of the set, a word-commonness score may be assigned to that word which is representative of the word-commonness of that word within the corpus of electronic documents. As one example, the word-commonness score assigned to a word may correspond to the number of occurrences of that word within the corpus of electronic documents. As another example, the word-commonness score assigned to a word may correspond to a scaled or normalized version of the number of occurrences of that word within the corpus. As a non-limiting example, a word-commonness scoring system having a total of five (5) different values for word-commonness may be obtained by scaling a total count of each word of the set according to a logarithmic scale. For example, if the word “FRIEND” is present 10,000 times in a given corpus of electronic documents, that word may be assigned a word-commonness score of 5 out of 5. By contrast, if only a single occurrence of the word “FLAVONE” is present in the corpus, that word may be assigned a word-commonness score of 1 out of 5, since the word “FLAVONE” is five factors-of-ten less prevalent in the corpus than the word “FRIEND”. It will appreciated that any suitable number of discrete or continuous word-commonness scores may be used to define word-commonness, including two, three, four, more than five, tens, hundreds, or more. Any suitable scaling factor may be applied to the set of words, including logarithmic, non-logarithmic, proportional, exponential, etc.

At 616, the set of words may be sorted according to the word-commonness of each word relative to the other words of the set to obtain a sorted list of the set of words. The sorted list may define an order of the words of the set that is based, at least in part, on the word-commonness of each word relative to the other words of the set. The sorted list may include a respective word-commonness score assigned to each word of the set. For example, the sorted list may define an order of the words from highest to lowest assigned word-commonness score, or from lowest to highest word-commonness score. It is to be understood that various data structures, forms of metadata, database concepts, and/or other techniques may be used to “sort” a list as described herein. In general, a list is sorted in accordance with this disclosure if the relative commonness of one entry (e.g., word) may be assessed in comparison to the relative commonness of another entry (e.g., another word) regardless of how the words are saved and/or catalogued. For example, the various words from a set need not be saved in any particular memory location, with any particular indexing, and/or with any particular cataloging to be considered sorted as used herein.

At 618, the sorted list or a subset thereof may be output. In the context of a computer implementation of method 600, the sorted list optionally may be output as a computer readable data structure and/or file. The computer readable file may be stored in a storage device for retrieval by a computer system. As another example, the sorted list may be output from an individual program module within a larger program for use by another module of the larger program or by a different program executed by a computing system. As yet another example, the sorted list may be output for presentation via a display subsystem of a computer system or physically printed to a tangible printing medium by a printing device.

In at least some implementations, the sorted list may be output in a format readable by a word-game program to construct a game interface that includes at least a threshold number of less common words and at least a threshold number of more common words as identified by the sorted list. The less common words may be distinguished from the more common words based, at least in part, on the word-commonness score assigned to those words. For example, more common words may be assigned word-commonness scores that are greater than a threshold word-commonness score (e.g., greater than or equal to 3 out of 5) and less common words may be assigned word-commonness scores of less than a threshold word-commonness score (e.g., less than 3 out of 5).

In the context of a word-game, the set of words may form a pool of word-puzzle answers. For example, as previously described with reference to FIG. 5, for each of a plurality of empty game-object locations in a game interface, a game-object may be loaded into that empty game-object location to construct a game interface that is fully loaded with game-objects that form a set of puzzle-answers. A rule-set may be applied to the game interface. For example, the set of word-puzzle answers may include at least a threshold number of less common words assigned a word-commonness score within a first range (e.g., less than 3 out of 5) and at least a threshold number of more common words assigned a word-commonness score within a second range (e.g., greater than or equal to 3 out of 5). It will be appreciated that word-commonness may be used to compare a game interface to any suitable rule-set, including other example rule-sets previously described with reference to FIG. 5.

In at least some implementations, the sorted list may be output in a format readable by a spell checker and/or word completion program. The set of words of the sorted list may form a pool of recommended words. As one example, the sorted list of the recommended words may be output as recommended spellings of misspelled words for use by a spell checker program. As another example, where a word completion program forms part of a search engine, the word completion program may output the sorted list of the recommended words as recommended completions of partially entered search terms.

A spell checker and/or word completion program may refer to a program that provides one or more recommended words for a word or word portion proffered by a user. For example, in response to a user typing the word “CARZ”, a spell checker program may recommend one or more of the words “CARS”, “CAR”, “CZAR”, “CART”, etc. These recommended words may have a priority relative to each other for a proffered word. For example, the word “CARS” may have priority over the word “CZAR” in the above example. A word completion program may also refer to a program that provides one or more recommended words for a word or word portion proffered by a user. For example, in response to a user typing the word portion “CA”, a word completion program may recommend one or more of the words “CAR”, “CAT”, “CARS”, “CART”, etc. These recommended words may also have a priority relative to each other for a proffered word. For example, the word “CAR” may have priority over the word “CART” in the above example. A spell checker and/or word completion program may form part of or may be integrated with word processing programs, internet search engines, SMS/text message client programs, email client programs, etc. A spell checker and/or word completion program may be executed at a client device or at a server device accessible by a client device over a communications network.

The spell checker and/or word completion program may vary a priority of one or more recommended words within a set of recommended words output by the program based, at least in part, on the word-commonness of one or more words of the set of recommended words identified by the sorted list. For example, the spell checker and/or word completion program may define the priority of one or more recommended words based, at least in part, on the commonness of those words identified from the sorted list. In the above examples, if the word “CAR” is identified as being more common than the word “CZAR” by the sorted list, the spell checker and/or word completion program may define the word “CAR” as having a higher priority than the word “CZAR” in the set of recommended words.

The sorted list may be applied by these or other programs, for example, as described with reference to process 630 of method 600. The sorted list may also be applied to the creation of game interfaces, such as described with reference to processes 620-628 of method 600. For example, at 620, a game interface may be constructed having a plurality of word-game-object locations. The construction of the game interface may be in accordance with previously described method 500 of FIG. 5, for example. Different combinations of adjacent word-game-objects may form puzzle-answer words from the set of words as previously described, for example, with reference to FIG. 1.

At 622, the game interface may be deployed to an electronic gaming environment for presentation. The electronic gaming environment may include one or more client devices each operated by a respective player. In some implementations, each client device may be operated by two or more players of a team or as adversaries in a multi-player role. As previously described, these client devices may communicate over a communications network to receive a game-object arrangement defining the game interface.

At 624, one or more player responses may be received from the electronic gaming environment. Each player response may indicate one or more valid puzzle-submission words identified by the player within the game interface. As one example, the player responses may be indicated by individual results information. As another example, an application program residing at each client device may compile a list of valid puzzle-submission words identified by a player over one or more game rounds. This list may be transmitted to a server system by the client device over a communications network.

At 626, one or more results summaries may be generated based, at least in part, on the one or more player responses. For each player response, a comparison of the puzzle-submission words to the puzzle-answer words may be performed to identify valid puzzle-submission words that are present within the puzzle-answer words. FIGS. 2 and 3 provide non-limiting examples of results summaries that may be generated.

In at least some implementations, the results summary may be programmatically generated from player response information without necessarily involving human intervention. As previously described with reference to FIG. 3, the results summary may indicate a more common subset of the puzzle-answer words having at least a threshold frequency (e.g., word-commonness) within the corpus and a less common subset of the puzzle-answer words having less than the threshold frequency (e.g., word-commonness) within the corpus.

As one example, the more common subset of puzzle-answer words may include puzzle-answer words not present in the puzzle-submission words of a player response (e.g., words not found by the player) having at least the threshold frequency within the corpus (e.g., word-commonness). The less common subset of puzzle-answer words may include puzzle-answer words not present in the puzzle-submission words of the player response (e.g., words not found by the player) having less than the threshold frequency within the corpus (e.g., word-commonness).

As another example, the more common subset of puzzle-answer words may include puzzle-answer words that are present in the puzzle-submission words of a player response (e.g., words found by the player) having at least the threshold frequency within the corpus (e.g., word-commonness). The less common subset of puzzle-answer words may include puzzle-answer words that are present in the puzzle-submission words of the player response (e.g., words found by the player) having less than the threshold frequency within the corpus (e.g., word-commonness).

In at least some implementations, letter-commonness may be identified and applied to game interface generation using techniques that are similar to those of word-commonness described above. As one example, for each letter of an alphabetic system of the language, a letter-commonness of that letter may be identified within the corpus of electronic documents. The letter-commonness identified for a letter may be based, at least in part, on a frequency of that letter within the corpus of electronic documents for which that letter is a member of one or more words. As one example, the frequency of a letter may represent a total or relative count of that letter within the corpus of electronic documents.

The letters may be sorted according to the letter-commonness of each letter relative to the other letters of the alphabetic system to obtain a sorted list of the letters. The sorted list of the letters may have an order that is based, at least in part, on the letter-commonness of each letter relative to the other letters of the alphabetic system. For each letter of the alphabetic system, a letter-commonness score may be assigned to that letter which is representative of the letter-commonness of that letter relative to the letter-commonness of the other letters of the alphabetic system. A letter-commonness score may be scaled and/or may have any suitable scoring range.

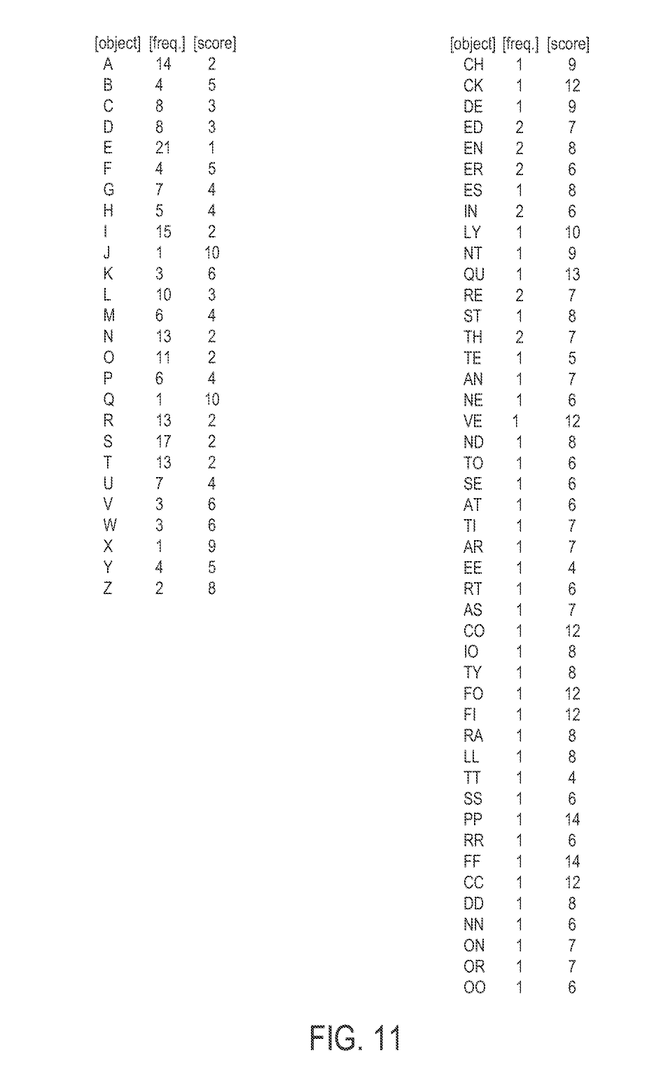

Although letter-commonness scores may depend, at least in part, on the particular corpus from which they were generated, and may be updated from time to time, example letter-commonness scores for the English language alphabet are listed in FIG. 11. In FIG. 11, 26 letters of the English language alphabet and an example selection of diagrams are each presented with a corresponding frequency of that letter or diagram within the corpus. It will be understood that the examples of FIG. 11 are non-limiting examples, and that other scores and/or scoring ranges may be used.

The sorted list of the letters may be output and may include a respective letter-commonness score assigned to each of the letters of the alphabetic system. The sorted list of letters may be output in a format that is readable by the word-game program, the spell checker and/or word completion program, or other suitable program as discussed above with respect to the sorted list of words. The sorted list of letters may also be output by presentation via a display subsystem or by printing to a tangible medium by printing device.

In the context of a word-game program, for each of a plurality of empty game-object locations in a game interface, a game-object may be selected from a pool of game-objects. Each game-object may include one or more letters of the alphabetic system. The representation of each letter of the alphabetic system within the pool of game-objects may be based, at least in part, on the letter-commonness score assigned to that letter. Accordingly, a game interface generated from a pool of game-objects that include letters may be representative of the letters present within the corpus of electronic documents. A non-limiting example of a pool of game-objects to which letter-commonness may be applied was previously described with reference to FIG. 5.

A plurality of player responses may be received from the electronic gaming environment. Each player response may indicate one or more puzzle-submission words identified by a respective player. Player responses may be used as feedback to vary a word-commonness score assigned to a particular word of the set.

In the context of a game program, at 632, a word of the set of words may be transferred from a more common subset to a less common subset responsive to that word being indicated by less than a threshold number of the plurality of player responses. A word of the set of words may be transferred from the less common subset to the more common subset responsive to that word being indicated by more than a threshold number of the plurality of player responses. This transfer may be for the current game play phase and/or one or more future game rounds. Player responses may be aggregated for a single game round or a number of game rounds occurring over time to be used as player response feedback used to vary word-commonness of one or more words of the set. For example, word-commonness for a given word may be varied over time based on how often that word is identified as a user-submission word over a number of game rounds played over time by one or more players.

In the context of a spell checker and/or word completion program, at 634, a priority of a recommended word within a set of recommended words may be demoted in priority responsive to that recommended word being indicated by less than a threshold number of the plurality of player responses received from the gaming environment. A priority of a recommended word within a set of recommended words may be promoted in priority responsive to that word being indicated by more than a threshold number of the plurality of player responses received from the gaming environment.

Word-commonness may be identified for a different corpus of electronic documents to update prior word-commonness findings. The different corpus may be a subset or a superset of the original corpus. Accordingly, the different corpus may include at least some (or none) of the electronic documents present within the original corpus and at least some new electronic documents not present within the original corpus (or no new electronic documents). For example, at 610, a computer program may be applied to a different corpus of electronic documents to identify a word-commonness for each word of the set of words within the different corpus of electronic documents based, at least in part, on a frequency of that word within the different corpus. In the context of a game program, at 630, a word of the set of words may be transferred from one of the more common subset or the less common subset to the other of the more common subset or the less common subset based, at least in part, on the word-commonness for that word identified within the different corpus of electronic documents. In the context of a spell checker and/or word completion program, at 632, a priority of a recommended word within a set of recommended words may be promoted or demoted based, at least in part, on the word-commonness for that recommended word identified within the different corpus of electronic documents. Letter-commonness may be similarly identified for a different corpus of electronic documents to update prior letter-commonness findings.

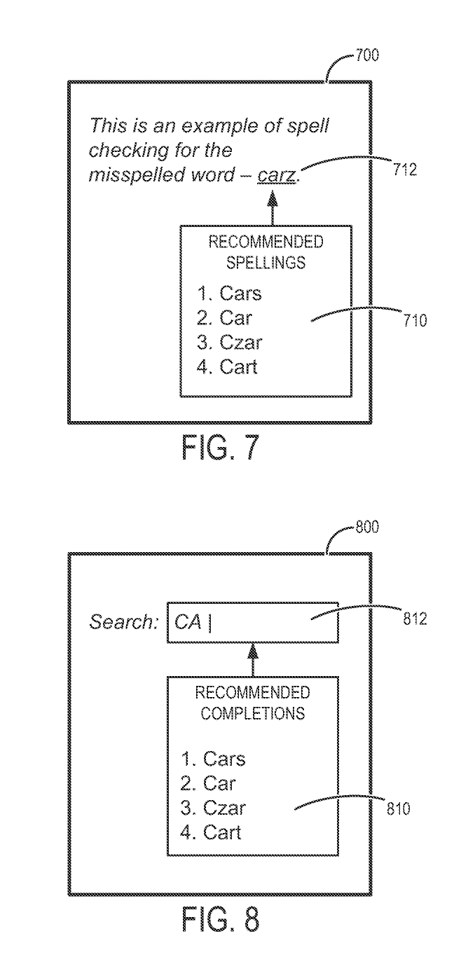

FIG. 7 shows an example GUI 700 of a spell checker program. GUI 700. The spell checker program presents recommended spellings 710 for a misspelled word 712 proffered by a user. The recommended spellings 710 may have an order or priority that is based, at least in part, on the word-commonness of those recommended spellings. A user may select a word from the recommended spellings 710 to replace or complete misspelled word 712.

FIG. 8 shows an example GUI 800 of a word completion program. In the example of FIG. 8, the word completion program forms part of a search engine. The word completion program presents recommended completions 810 of a partially entered search term 812. Recommended completions 810 may have an order or priority that is based, at least in part, on the word-commonness of those recommended completions. A user may select a word from the recommended completions 810 to replace or complete partially entered search term 812.

In some embodiments, the above described methods and processes may be tied to a computing system including one or more computing devices. In particular, the methods and processes described herein may be implemented as a computer application program, computer service, computer API, computer library, and/or other computer program product.

FIG. 9 schematically shows a non-limiting computing system 910 that may perform one or more of the above described methods and processes. Computing system 910 is shown in simplified form. It is to be understood that virtually any computer architecture may be used without departing from the scope of this disclosure. In different embodiments, computing system 910 may take the form of a mainframe computer, server computer, desktop computer, laptop computer, tablet computer, home entertainment computer, network computing device, mobile computing device, mobile communication device (e.g., smart phone), gaming device, etc.

Computing system 910 includes a logic subsystem 912 and a storage subsystem 914. Computing system 910 may optionally include a display subsystem 916, input device subsystem 918, communication subsystem 920, and/or other components not shown in FIG. 9. Computing system 910 may also optionally include or interface with user input devices such as keyboards, mice, game controllers, cameras, microphones, and/or touch screens, for example. These user input devices may form part of input device subsystem 918 or may interface with input device subsystem 918.

Logic subsystem 912 includes one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem 914 includes one or more physical, non-transitory, devices configured to hold data and/or instructions executable by the logic subsystem to implement the herein described methods and processes. When such methods and processes are implemented, the state of storage subsystem 914 may be transformed (e.g., to hold different data).

Storage subsystem 914 may include removable media and/or built-in devices. Storage subsystem 914 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Storage subsystem 914 may include devices with one or more of the following characteristics: volatile, nonvolatile, dynamic, static, read/write, read-only, random access, sequential access, location addressable, file addressable, and content addressable. In some embodiments, logic subsystem 912 and storage subsystem 914 may be integrated into one or more common devices, such as an application specific integrated circuit or a system on a chip.

It is to be appreciated that storage subsystem 914 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 910 that is implemented to perform one or more particular functions. In some cases, such a module, program, or engine may be instantiated via logic subsystem 912 executing instructions held by storage subsystem 914. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on one or more server computing devices.

When included, display subsystem 916 may be used to present a visual representation of data held by storage subsystem 914. This visual representation may take the form of a graphical user interface (GUI). As the herein described methods and processes change the data held by the storage subsystem, and thus transform the state of the storage subsystem, the state of display subsystem 916 may likewise be transformed to visually represent changes in the underlying data. Display subsystem 916 may include one or more display devices utilizing virtually any type of technology. Such display devices may be combined with logic subsystem 912 and/or storage subsystem 914 in a shared enclosure, or such display devices may be peripheral display devices.

When included, communication subsystem 920 may be configured to communicatively couple computing system 910 with one or more other computing devices. Communication subsystem 920 may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computing system 910 to send and/or receive messages to and/or from other devices via a network such as the Internet.

FIG. 10 is a schematic diagram depicting a network of computing devices forming a computing system 1000. Computing system 910 of FIG. 9 is a non-limiting example of the various computing devices of FIG. 10.

A computing system may include one or more client devices and one or more server devices. For example, computing system 1000 includes a number of client devices 1010, 1012, 1014, 1016, etc. operated by human users (e.g., players) that may communicate with a number of server devices 1020, 1022, 1024, etc. over a communications network. One or more server devices may collectively form a server system. Server devices 1020, 1022, 1024, etc. may write data to and/or read data from one or more storage devices, such as storage devices 1030, 1032, 1034, etc. These storage devices may be accessible to the server devices over a communications network or may be co-located with the server devices.

Computing system 1000 may include any number of client devices, server devices, and storage devices. These client devices, server devices, and storage devices may be geographically distributed. For example, computing system 1000 may include one, tens, hundreds, thousands, millions, or more client devices, each operated by a respective human user located in different geographic locations. In FIG. 10, example communication paths are depicted over the communications network by arrows. For example, client devices may communicate with one or more server devices, and servers devices may in turn communicate with one or more storage devices. As further indicated by these communication paths, server devices may communicate with each other, storage devices may communicate with each other, and/or server devices may communicate with some or all of the storage devices over the communications network.

In one example implementation of method 500, candidate game interfaces may be generated, tested, and rejected or approved by one or more of server devices 1020, 1022, 1024, etc. using information (e.g., a set of words, word-commonness, letter-commonness, electronic documents, etc.) obtained from one or more of storage devices 1030, 1032, 1034, etc. The approved game interfaces may be deployed to client devices 1010, 1012, 1014, 1016, etc. as game-object arrangements for game play. Responses to these game interfaces may be received from client devices 1010, 1012, 1014, 1016, etc. at one or more of server devices 1020, 1022, 1024, etc. Responses may be processed at one or more of server devices 1020, 1022, 1024, etc. to obtain results data. Results data may be transmitted from one or more of server devices 1020, 1022, 1024, etc. to client devices 1010, 1012, 1014, 1016, etc. and/or stored at one or more of storage devices 1030, 1032, 1034, etc.

In another example implementation of method 500, candidate game interfaces may be generated, tested, and/or rejected or approved locally at client devices 1010, 1012, 1014, 1016, etc. Responses to game interfaces by players received during game play may be processed locally at client devices 1010, 1012, 1014, 1016, etc. and/or may be transmitted to one or more of server devices 1020, 1022, 1024, etc. for processing and/or dissemination to other locations, including one or more storage devices or other client devices.

According to an implementation of method 600, individual results information may be received from each of a plurality of client devices over the communications network by one or more server devices. As a non-limiting example, individual results information for a first subset of the plurality of client devices may be received over the communications network via a first server device during a first portion of the intermediate phase. As previously described, an intermediate phase may follow an early phase (e.g., game play phase). Individual results information for a second subset of the plurality of client devices may be received over the communications network via a second server device during the first portion of the intermediate phase. The second server device may be geographically remote from the first server device in some examples.

The servers may store results collected from client devices at one or more of storage devices 1032, 1034, 1036, etc. One or more storage devices may include a pair of databases. A first database may be used for real-time results information and a second database may be used for persistent results information. The real-time results may form a subset of the persistent results. For example, the real-time results may include only validated results, whereas the persistent results may also include un-validated results.

During aggregation of the individual results information, each server may perform a query of individual results information for each player from the real-time results database. The real-time results database may organize the individual results information based on game score and/or rank. The real-time results database may include individual results information that is limited to a specific time-based threshold (e.g., based on a time stamp) to ensure that each client device is able to obtain the same aggregated results information, regardless of the particular server device from which the client device receives the aggregated results information.

The individual results information stored at the one or more storage devices may be associated with a timestamp indicating a time that the individual results information was received from a client device or a time that the individual results information was stored at a storage device. For each time stamp, if the time stamp for that individual results information is not within the first portion of the intermediate phase, that individual results information may be withheld from being aggregated with the aggregated results information transmitted to the client devices during the late phase.

Other results formats (e.g., persistent results information), including a non-real-time leader board such as leader boards that show “right now”, “this hour”, “today” and “this week”, etc. may be available to clients after the game round, even if that client's individual results information was withheld from the aggregated results information transmitted to one or more other client devices within the synchronized gaming schedule. Real-time results may be presented during a game play phase or after a game play phase during a results phase, in contrast to non-real-time results (e.g., persistent results information) which may be available to players outside of these phases, such as upon request or published to an accessible network location, such as a website.

Individual results information may be aggregated by combining the individual results at one or more storage devices during a second portion of the intermediate phase following the first portion. In at least some implementations, the aggregated results information may be stored at two, three, or more storage devices to increase redundancy of the computing system in the event of failure of an individual storage device. The aggregated results information may be transmitted to each client device of the first subset over the communications network via the first server device during the second portion of the intermediate phase.

The aggregated results information may be transmitted to each client device of the second subset over the communications network via the second server device during the second portion of the intermediate phase. In at least some implementations, individual results information stored at the one or more storage devices may be retrieved by server devices in an order corresponding to the highest game-score value and/or rank to the lowest game-score value and/or rank to reduce delay in providing top results to the client devices.

As one example, within seconds after the beginning of the next game play phase, a server device may query the database containing the persistent results information to create a persistent leader board. The persistent leader board may provide an indication of player scores and/or rank as the “best of right now”, “best of the hour”, “best of the day”, and/or “best of the week”, for example. The server device may perform a query of all results from the persistent results database without any form of time-based thresholding (e.g., based on time stamps) that was applied during aggregation of the individual results information. This ensures that even if individual results information arrived after the time threshold, it will be aggregated into the persistent leader board.

While the above description is directed to a word game that utilizes a word-game interface including a four-by-four matrix of game-object locations to arrange sixteen different game-objects, the concepts described herein can be applied to other games including game interfaces of different sizes and shapes, game interfaces having different objectives or goals, and game interfaces having different rules for game play. Furthermore, while game-objects that include one or more letters are used in the above described examples, other games may utilize different game-objects, which may include numbers, glyphs, graphics, and/or other information. As such, it is to be understood that this disclosure is not limited to word-games using four-by-four game interfaces.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for a computing system, comprising:
transmitting a game-object arrangement defining a game interface over a communications network for presentation at a plurality of client devices during an early phase of a synchronized gaming schedule shared among the client devices;
transmitting an answer key indicating one or more puzzle-answers over the communications network that enables an application program residing at each of the client devices to generate and present, during an intermediate phase of the synchronized gaming schedule following the early phase, an individual results summary, the individual results summary based on a comparison of one or more puzzle-submissions supplied by a player to the one or more puzzle-answers of the answer key;
receiving individual results information from each client device over the communications network indicating the comparison of the one or more puzzle-submissions by a player of that client device to the one or more puzzle-answers of the answer key;
aggregating the individual results information received from each of the client devices to obtain aggregated results information, said receiving and aggregating performed during the intermediate phase; and
transmitting the aggregated results information to each of the client devices over the communications network for presentation at the client devices during a late phase of the synchronized gaming schedule.

2. The method of claim 1, wherein the individual results information received from each client device indicates a game-score value and an identity of that client device or player of that client device, the game-score value based, at least in part, on the comparison of the one or more puzzle-submissions to the one or more puzzle-answers.

3. The method of claim 2, wherein aggregating the individual results information includes sorting the individual results information to identify one or more top game-score values of the plurality of client device;
wherein the aggregated results information transmitted to each of the client devices indicates the one or more top game-score values.

4. The method of claim 3, wherein the aggregated results information further indicates the identity attributed to each of the one or more top game-score values.

5. The method of claim 1, wherein the individual results information is received as an encrypted value from each client, the application program at each client device encrypting the individual results information transmitted by that client device to obtain the encrypted value.

6. The method of claim 5, further comprising:
validating the individual results information received from each client device based, at least in part, on the encrypted value for that client device;
for each client device, if the individual results information is validated for that client device, aggregating the individual results information received from that client device into the aggregated results information; and
for each client device, if the individual results information is not validated for that client device, withholding the individual results information received from that client device from aggregation with the aggregated results information transmitted to one or more other client devices.

7. The method of claim 6, further comprising:
for each client device, if the individual results information is not validated for that client device, aggregating the individual results information received from that client device into the aggregated results information transmitted to only that client device such that the aggregated results information transmitted to that client device differs from the aggregated results information transmitted to all other client devices.

8. The method of claim 1, wherein the aggregated results information transmitted to each client device enables the application program residing at that client device to present an aggregated results summary, the aggregated results summary including an indication of a relative ranking of a player of that client device based on the individual results information received from that client device relative to individual results information received from other players of the other client devices.

9. The method of claim 8, wherein the aggregated results information transmitted to the client device further indicates a relative ranking of one or more socially-connected players of the different client device.

10. The method of claim 1, wherein receiving the individual results information from each client device over the communications network includes:
for a first subset of the plurality of client devices, receiving the individual results information from each client device of the first subset over the communications network via a first server device during a first portion of the intermediate phase; and
for a second subset of the plurality of client devices, receiving the individual results information from each client device of the second subset over the communications network via a second server device geographically remote from the first server device during the first portion of the intermediate phase.

11. The method of claim 10, wherein aggregating the individual results information includes combining, at a storage device, the individual results information received from each client device of the first subset with the individual results information received from each client device of the second subset; and
wherein transmitting the aggregated results information includes:
for the first subset of the plurality of client devices, transmitting the aggregated results information to each client device of the first subset over the communications network via the first server device during the second portion of the intermediate phase; and
for a second subset of the plurality of client devices, transmitting the aggregated results information to each client device of the second subset over the communications network via the second server device during the second portion of the intermediate phase.

12. The method of claim 10, wherein, for each client device, the individual results summary for that client device indicates a game-score value; and
wherein the method further comprises retrieving the individual results information stored at the storage device in an order corresponding to the highest game-score value to the lowest game-score value.

13. The method of claim 10, wherein storing the individual results information at the storage device includes associating a timestamp with the individual results information stored for each client device;
for each time stamp, if the individual results information for that time stamp is not within the first portion of the intermediate phase, withholding that individual results information from aggregation with the aggregated results information transmitted to the client devices.

14. A computing system, comprising:
a server system configured to:
transmit a game-object arrangement defining a game interface over a communications network for presentation at a plurality of client devices during an early phase of a synchronized gaming schedule shared among the client devices;
transmit an answer key indicating one or more puzzle-answers over the communications network that enables an application program residing at each of the client devices to generate and present, during an intermediate phase of the synchronized gaming schedule following the early phase, an individual results summary, the individual results summary based on a comparison of one or more puzzle-submissions by a player to the one or more puzzle-answers of the answer key;
receive individual results information from each client device over the communications network indicating the comparison of the one or more puzzle-submissions supplied by a player of that client device to the one or more puzzle-answers of the answer key;
aggregate the individual results information received from each of the client devices to obtain aggregated results information during the intermediate phase; and
transmit the aggregated results information to each of the client devices over the communications network for presentation at the client devices during a late phase of the synchronized gaming schedule.

15. The computing system of claim 14, wherein the individual results information received from each client device indicates a game-score value and an identity of that client device or player of that client device, the game-score value based, at least in part, on the comparison of the one or more puzzle-submissions to the one or more puzzle-answers.

16. The computing system of claim 15, wherein individual results information is aggregated by sorting the individual results information to identify one or more top game-score values of the plurality of client device;
wherein the aggregated results information transmitted to each of the client devices indicates the one or more top game-score values.

17. The computing system of claim 16, wherein the aggregated results information further indicates the identity attributed to each of the one or more top game-score values.

18. The computing system of claim 14, wherein the aggregated results information transmitted to each client device enables the application program residing at that client device to present an aggregated results summary, the aggregated results summary including an indication of a relative ranking of a player of that client device based on the individual results information received from that client device relative to individual results information received from other players of the other client devices.

19. The computing system of claim 18, wherein the server system is further configured to:
wherein the aggregated results information transmitted to one or more of the client devices further indicates a relative ranking of one or more socially-connected players of one or more different client devices.

20. A storage subsystem holding instructions executable by a logic subsystem to:
receive a game-object arrangement defining a game interface over a communications network at a client device from a server system during an early phase of a synchronized gaming schedule shared with one or more other client devices;
present the game interface defined by the game-object arrangement via a display subsystem, the game interface including a plurality of word-game-objects, each word-game-object including a letter or a combination of two or more letters, and different combinations of adjacent word-game-objects forming puzzle-answer words;
receive one or more puzzle-submission words supplied by a player during the early phase;
receive an answer key indicating one or more puzzle-answers over the communications network at the client device from the server system; during an intermediate phase of the synchronized gaming schedule following the early phase, generate an individual results summary based on a comparison of the one or more puzzle-submissions words to the puzzle-answer words of the answer key:
transmit individual results information over the communications network to the server system indicating the comparison of the one or more puzzle-submission words to the one or more puzzle-answer words of the answer key;
receive aggregated results information over the communications network at the client device from the server system, the aggregated results information including an indication of a relative ranking of the player of the client device relative to other players; and
present the aggregated results information via the display subsystem during a late phase following the intermediate phase.
